(19) United States
(12) Patent Application Publication
(10) Pub. No.: US 2025/0211268 A1
(43) Pub. Date: Jun. 26, 2025

(54) ELECTRONIC CIRCUIT FOR ANTENNA DEVICES

(71) Applicant: YOKOWO CO., LTD., Tokyo (JP)

(72) Inventors: Yusuke YOKOTA, Gunma (JP); Tomohiro HOSHI, Gunma (JP)

(73) Assignee: YOKOWO CO., LTD., Tokyo (JP)

(21) Appl. No.: 18/851,712

(22) PCT Filed: Feb. 8, 2023
(86) PCT No.: PCT/JP2023/004195

§ 371 Date: Sep. 27, 2024

(30) Foreign Application Priority Data
Mar. 29, 2022 (JP) 2022-054598
Oct. 21, 2022 (JP) 2022-169197

(51) Int. Cl. H04B 1/10; H04B 1/18

(52) U.S. Cl. CPC H04B 1/10; H04B 1/18

(57) ABSTRACT

An electronic circuit for antenna device, the electronic circuit being configured to be connected to an antenna and includes: a band pass filter configured to pass a signal in a target frequency band; a first band elimination filter whose one end is connected to one end of the band pass filter; and a second band elimination filter whose one end is connected to the other end of the band pass filter. The first band elimination filter and the second band elimination filter dividually eliminate passage of signals at frequencies out of the target frequency band.

### TECHNICAL FIELD

The present invention relates to an electronic circuit for antenna device that can be mounted in a limited space of a mobile object.

### BACKGROUND ART

For an antenna device mounted on a vehicle, which is an example of a mobile object, it is difficult to provide a wide space for installing antennas for a plurality of frequency bands. Therefore, one antenna is often shared by circuitries (amplifiers and the like) that operate in a plurality of frequency bands. However, it is difficult to ensure mutual isolation (a degree of eliminating interference) if the antenna or the plurality of circuitries are close to each other.

As a technique for ensuring isolation in the related art, an antenna module disclosed in Patent Literature 1 is known. In the antenna module disclosed in Patent Literature 1, a first circuitry for processing a signal in a first frequency band and a second circuitry for processing a signal in a second frequency band are connected to one antenna. The second circuitry includes: a variable gain amplifier for amplifying a signal in the second frequency band; and a detector for detecting a level of an output signal of the variable gain amplifier and outputting a control signal for changing an amplification degree of the variable gain amplifier based on the detection result to configure an automatic gain control (AGC) circuit. In addition, a filter for attenuating a signal in the first frequency band is provided between the variable gain amplifier and the detector to enhance the isolation, thereby preventing a malfunction of the AGC circuit due to a signal transmitted from the antenna. A band pass filter (BPF) is used as the filter.

### CITATION LIST

### Patent Literature

Patent Literature 1: JP2015-211288A

### SUMMARY OF INVENTION

### Technical Problem

According to the antenna module disclosed in Patent Literature 1, a signal transmitted from the antenna is not directly input to the detector of the second circuitry. Therefore, it is possible to prevent a malfunction of the AGC in the second circuitry due to a signal transmitted from the antenna.

However, the causes of the malfunction of the circuitry exist not only in the signal transmitted from the antenna but also in the plurality of electrically connected circuitries. For example, spuriouses generated from active elements or lines of any circuitry (signals of unintended frequency components in design, for example, high modulation wave signals, ripple components, etc.), reflected waves of an input signal to the circuitry due to mismatch with the antenna, and the like also cause a malfunction of the circuitry.

In addition, if the first frequency band processed by any one of the circuitries is near the lower limit frequency or near the upper limit frequency of the BPF designed for the second frequency band processed by another circuitry, the signal in the first frequency band cannot be attenuated, which may cause a malfunction of the other circuitry.

An example of an object of the present invention is to limit spuriouses in a case where a plurality of circuitries are electrically connected, which cause a malfunction of any circuitry, nonlinear operations of an amplifier, a carrier to noise (C/N) ratio reduction, and the like.

Other objects of the present invention will become apparent from the description of this specification.

### Solution to Problem

An aspect of the present invention is an electronic circuit for antenna device. The electronic circuit is configured to be connected to an antenna and includes: a band pass filter configured to pass a signal in a target frequency band; a first band elimination filter whose one end is connected to one end of the band pass filter; and a second band elimination filter whose one end is connected to the other end of the band pass filter. The first band elimination filter and the second band elimination filter dividually eliminate passage of signals at frequencies out of the target frequency band.

An aspect of the present invention is an electronic circuit for antenna device. The electronic circuit is configured to be connected to an antenna configured to be used in a first frequency band and a second frequency band higher than the first frequency band, and includes: a first circuitry configured to process a signal in the first frequency band; and a second circuitry connected to the first circuitry via a filter circuitry and configured to process a signal in the second frequency band. The filter circuitry includes a band pass filter configured to pass the signal in the first frequency band, a first band pass filter whose one end is connected to one end of the band pass filter and whose other end is conducted to one of the first circuitry and the second circuitry, and a second band elimination filter whose one end is connected to the other end of the band elimination filter and whose other end is conducted to the other of the first circuitry and the second circuitry. The first band elimination filter and the second band elimination filter dividually eliminate passage of signals at frequencies equal to or lower than a lower limit frequency of the second frequency band, and near an upper limit frequency and near a lower limit frequency of the first frequency band.

### Advantageous Effects of Invention

According to the above-described aspect of the present invention, it is possible to limit spuriouses in a case where a plurality of circuitries are electrically connected, which cause a malfunction of any circuitry, nonlinear operations of an amplifier, a C/N ratio reduction, and the like.

### BRIEF DESCRIPTION OF DRAWINGS

FIG. 1 is a block diagram illustrating a configuration example of an antenna device according to a first embodiment.

FIG. 2 is a diagram illustrating a configuration example of a filter circuitry according to the first embodiment.

FIG. 3 is a configuration diagram of a related filter as a comparative example of the first embodiment.

FIG. 4 is a diagram illustrating an example of passing loss characteristics of the filter circuitry according to the first embodiment.

FIG. 5 is a diagram illustrating a modification of the filter circuitry according to the first embodiment.

FIG. 6 is a diagram illustrating an example of passing loss characteristics of the filter circuitry of the first embodiment and the modification.

FIG. 7 is a diagram illustrating another modification of the filter circuitry according to the first embodiment.

FIG. 8 is a diagram illustrating an example of passing loss characteristics of the filter circuitry of the first embodiment and the other modification.

FIG. 9 is a diagram illustrating a configuration example of a filter circuitry according to a second embodiment.

FIG. 10 is a configuration diagram of a related filter as a comparative example of the second embodiment.

FIG. 11 is a diagram illustrating an example of passing loss characteristics of the filter circuitry according to the second embodiment.

FIG. 12 is a diagram illustrating a modification of the filter circuitry according to the second embodiment.

FIG. 13 is a diagram illustrating an example of passing loss characteristics of the filter circuitry of the second embodiment and the modification.

FIG. 14 is a diagram illustrating another modification of the filter circuitry according to the second embodiment.

FIG. 15 is a diagram illustrating an example of passing loss characteristics of the filter circuitry of the second embodiment and the other modification.

FIG. 16 is a block diagram illustrating a configuration example of an antenna device according to a third embodiment.

FIG. 17 is a block diagram illustrating a configuration example of an antenna device according to a fourth embodiment.

FIG. 18 is a diagram illustrating an example of passing loss characteristics of a circuit board in the fourth embodiment.

### DESCRIPTION OF EMBODIMENTS

Hereinafter, a plurality of embodiments in which the present invention is applied to an antenna device mounted on a mobile object will be described. Here, an example of a case where the mobile object on which the antenna device is mounted is a vehicle will be described.

### First Embodiment

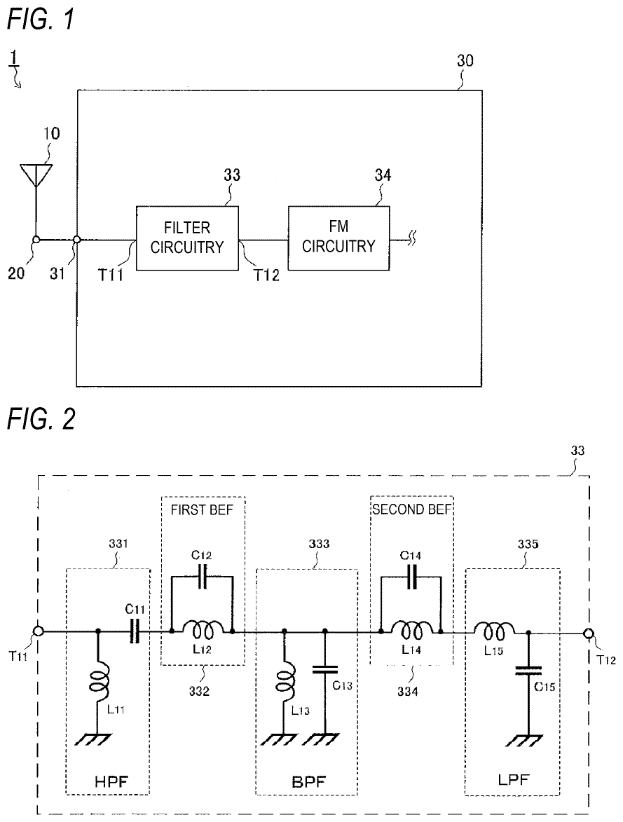

FIG. 1 is a block diagram illustrating a configuration example of an antenna device according to a first embodiment. The antenna device 1 includes an antenna 10 and a circuit board 30 that are housed in an antenna case (not illustrated). The antenna 10 has a structure in which an antenna element is conducted to a power supply unit 20. In this example, the antenna element receives an ultra-shortwave signal.

Examples of the ultra-shortwave signal include a digital audio broadcast (DAB) band signal and an FM broadcast signal. In the case of an FM broadcast signal, the specification frequency band of Japan is 76.1 MHz to 94.9 MHz, and some foreign countries take 87.5 MHz to 108 MHz as the specification frequency band. The following description will describe an example in which the frequency band whose C/N ratio or the like is to be improved, that is, the target frequency band is set to 76.1 MHz to 108 MHZ, which includes the FM wave bands of Japan and the foreign countries (first frequency band).

However, the same applies to the other media (specification frequency bands).

The circuit board 30 is one of antenna components obtained by providing an electronic circuit on a printed circuit board, for example. Such electronic circuit is an electronic circuit connected to the antenna 10. Therefore, the circuit board 30 is provided with an antenna connection terminal 31 electrically connected to the power supply unit 20 of the antenna 10.

The circuit board 30 is also provided with a filter circuitry 33 and an FM circuitry 34 for processing an FM broadcast signal. Although not illustrated, the FM circuitry 34 includes an FM amplifier, and an AGC attenuation circuit and an FM detector for detecting the intensity of the FM broadcast signal are provided previous to the FM amplifier. When a strong signal at a signal level higher than a reference is applied to the FM amplifier, the AGC attenuation circuit attenuates the signal level. By attenuating the signal level, the distortion of the FM amplifier can be reduced.

FIG. 2 is a diagram illustrating a configuration example of the filter circuitry 33. In the filter circuitry 33, an HPF (high-pass filter; hereinafter the same) 331, a first BEF (BEF is a band elimination filter; hereinafter the same) 332, a BPF (band pass filter; hereinafter the same) 333, a second BEF 334, and an LPF (low-pass filter; hereinafter the same) 335 are inserted and connected in series in this order in a signal transmission line between an input terminal T₁₁ and an output terminal T₁₂.

The BPF 333 passes a signal in the FM wave band. In the first embodiment, the BPF 333 is configured with an LC parallel resonance circuit in which an inductor (passive element as an example of an inductive element; the same hereinafter) L₁₃ and a capacitor (passive element as an example of a capacitive element; the same hereinafter) C₁₃ are connected in parallel to the ground.

In the BPF 333, the LC parallel resonance circuit is resonant (open) at the center frequency (parallel resonance frequency) of the FM wave band, and the part between the input and output terminals thereof, that is, between the connection point to the inductor L₁₃ and the connection point to the capacitor C₁₃ of the signal transmission line, is substantially open to the ground. Therefore, a signal between the input and output terminals of the BPF 333 passes with the minimum passing loss. On the other hand, the LC parallel resonance circuit is non-resonant at a frequency out of the FM wave band. Therefore, the impedance between the input and output terminals of the BPF 333 changes in correspondence with to the frequency, and the passing loss of the signal transmission line between the input and output terminals of the BPF 333 increases. That is, the signal input to the BPF 333 is attenuated. In the first embodiment, 92 MHz is taken as an example of the parallel resonance frequency. In this case, the inductor L₁₃ is, for example, 56 nH, and the capacitor C₁₃ is, for example, 56 pF.

The first BEF 332 and the second BEF 334 dividually eliminate passage of signals of frequencies out of the FM wave band. Specifically, the first BEF 332 dividually eliminates passage of a signal at a frequency in a first elimination frequency band, and the second BEF 334 dividually eliminates passage of a signal at a frequency in a second elimination frequency band.

The first BEF 332 may include an LC parallel resonance circuit in which a capacitor C₁₂ is connected between the input and output terminals, that is, between both ends of an inductor L₁₂ inserted and connected to the signal transmission line between the BPF 333 and the HPF 331. The first elimination frequency band is a band centered on a first elimination frequency (for example, 150 MHz) which is the parallel resonance frequency of the first BEF 332. The LC parallel resonance circuit is resonant if the frequency of the signal between the input and output terminals of the first BEF 332 is within the first elimination frequency band. Therefore, the passage of the signal at this frequency is eliminated. In this case, the inductor L₁₂ is, for example, 22 nH, and the capacitor C₁₂ is, for example, 51 pF.

The second BEF 334 may include an LC parallel resonance circuit in which a capacitor C₁₄ is connected between the input and output terminals, that is, between both ends of an inductor L₁₄ inserted and connected to the signal transmission line between the BPF 333 and the LPF 335. The second elimination frequency band is a frequency band centered on a second elimination frequency (for example, 50 MHz) which is the parallel resonance frequency of the second BEF 334. The LC parallel resonance circuit is resonant if the frequency of the signal between the input and output terminals of the second BEF 334 is within the second elimination frequency band. Therefore, the passage of the signal at this frequency is eliminated. In this case, the inductor L₁₄ is, for example, 100 nH, and the capacitor C₁₄ is, for example, 100 pF.

The HPF 331 eliminates or limits passage of a signal at a frequency equal to or lower than a first cutoff frequency. The HPF 331 also has a function of matching the characteristic impedance of the antenna 10 with the impedance of the signal transmission line of the filter circuitry 33. The HPF 331 may include: a capacitor C₁₁ inserted and connected to a signal transmission line between the input and output terminals, that is, between the first BEF 332 and the input terminal T₁₁; and an inductor L₁₁ whose one end is connected between the input terminal T₁₁ and the capacitor C₁₁ and whose other end is grounded. The first cutoff frequency can be set to a frequency (for example, 36 MHz) lower than the lower limit frequency of the first elimination frequency band (about 150 MHz) and the lower limit frequency of the second elimination frequency band (about 50 MHz). At this time, the capacitor C₁₁ is, for example, 33 pF, and the inductor L₁₁ is, for example, 330 nH.

The LPF 335 eliminates or limits passage of a signal at a frequency equal to or higher than a second cutoff frequency. The LPF 335 also has a function of matching the input impedance of the FM circuitry 34 with the impedance of the signal transmission line of the filter circuitry 33. The LPF 335 may include: an inductor L₁₅ inserted and connected to a signal transmission line between the input and output terminals, that is, between the second BEF 334 and the output terminal T₁₂; and a capacitor C₁₅ whose one end is connected between the output terminal T₁₂ and the inductor L₁₅ and whose other end is grounded. The second cutoff frequency can be set to a frequency (for example, 190 MHz) higher than the upper limit frequency of the first elimination frequency band (about 150 MHZ) and the upper limit frequency of the second elimination frequency band (about 50 MHz). In this case, the inductor L₁₅ is, for example, 120 nH, and the capacitor C₁₅ is, for example, 10 pF.

If the first cutoff frequency of the HPF 331 and the second cutoff frequency of the LPF 335 are too far from each other, a signal at a frequency unnecessary in design easily enters. In this case, the passing loss (signal attenuation amount) of frequencies near the lower limit frequency and near the upper limit frequency of the FM wave band may be smaller than that in the case of the BPF 333 alone. By connecting the first BEF 332 to one end of the BPF 333 (referred to as “input side” for convenience) and connecting the second BEF 334 to the other end of the BPF 333 (referred to as “output side” for convenience) as in the configuration example of FIG. 2, the passing loss of signals near the lower limit frequency and near the upper limit frequency of the FM wave band can be increased rapidly and significantly.

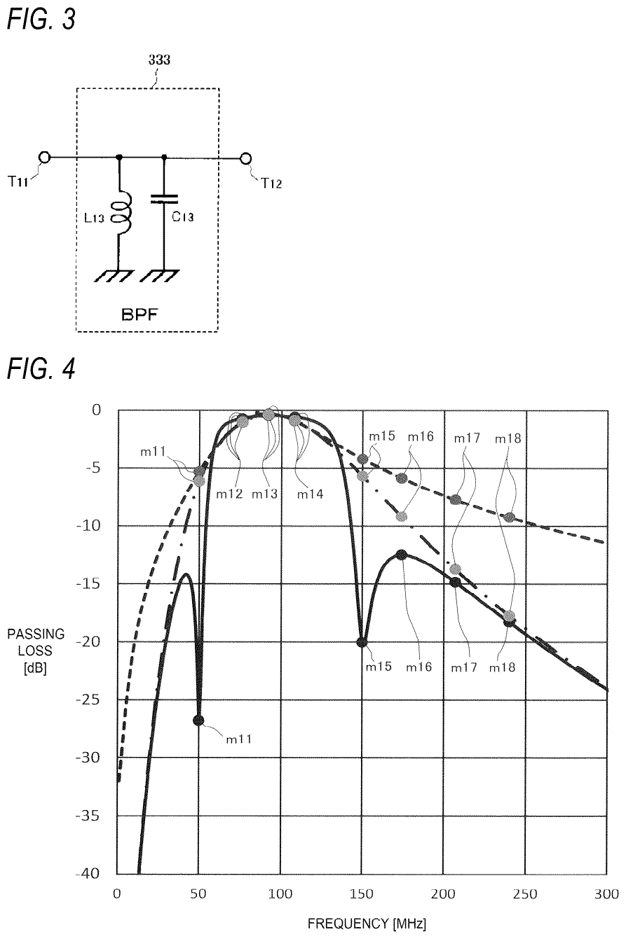

The passing loss characteristics of the filter circuitry 33 of the first embodiment configured as described above are illustrated by a solid line in FIG. 4. As a comparative example, the passing loss characteristics of a related filter #1 are indicated by a broken line. For example, as illustrated in FIG. 3, the related filter #1 has a simple configuration in which the BPF 333 is connected between the input terminal T₁₁ and the output terminal T₁₂ and the filter circuit unit 33 is configured with the BPF 333 alone. In an improved related filter configuration #1 as another comparative example, the HPF 331 is connected to one end of the related filter #1 without interposing the first BEF 332, and the LPF 335 is connected to the other end of the related filter #1 without interposing the second BEF 334. That is, in the improved related filter configuration #1, the filter circuitry 33 includes, for example, the HPF 331, the BPF 333, and the LPF 335 is connected between the input terminal T₁₁ and the output terminal T₁₂. The passing loss characteristics of the related improved configuration #1 are indicated by a one-dot chain line.

In FIG. 4, the vertical axis represents the passing loss (dB) of the signal transmission line, and the horizontal axis represents the frequency (MHz). m11 to m18 are points indicating the frequencies of interest for convenience of description. m11 is 50 MHz which is the second elimination frequency of the second BEF 334, m12 is 76 MHz which is the lower limit frequency of the FM wave band, m13 is 92 MHz which is the center frequency of the FM wave band, m14 is 108 MHz which is the upper limit frequency of the FM wave band, and m15 is 150 MHz which is the first elimination frequency of the first BEF 332.

Further, the frequencies corresponding to m16 to m18 are frequencies of interest in the DAB band (second frequency band) which may affect the FM wave band among the frequencies out of the FM wave band. m16 indicates 174 MHZ, m17 indicates 207 MHz, and m18 indicates 240 MHz.

As illustrated in FIG. 4, in the case of the filter circuitry 33 of the first embodiment, the passing loss is −26.8 dB at 50 MHz (m11) and −20.0 dB at 150 MHz (m15), which is rapidly increased near the lower limit frequency and near the upper limit frequency of the FM wave band.

In contrast, in the case of the related filter #1, the passing loss is −5.3 dB at 50 MHz (m11) and −4.2 dB at 150 MHz (m15). In the case of the improved related filter configuration #1, the passing loss is −6.1 dB at 50 MHz (m11) and −5.7 dB at 150 MHz (m15). That is, in the filter circuitry 33 of the first embodiment, the passing loss of a signal at a frequency out of the FM wave band is high. In particular, as compared with the comparative examples, the passing loss is increased rapidly near the lower limit frequency and near the upper limit frequency of the FM wave band.

At frequencies out of the FM wave band, the passing loss of the signal is −12.5 dB at 174 MHz (m16), −14.8 dB at 207 MHz (m17), and −18.3 dB at 240 MHz (m18), which is high at all the frequencies in the DAB band. In contrast, in the case of the related filter #1, the passing loss was −5.9 dB at 174 MHZ (m16), −7.7 dB at 207 MHz (m17), and −9.3 dB at 240 MHz (m18). In the case of the improved related filter configuration #1, the passing loss was −9.2 dB at 174 MHz (m16), −13.7 dB at 207 MHz (m17), and −17.7 dB at 240 MHz (m18). That is, the passing loss in the DAB band is higher in the filter circuitry 33 of the first embodiment than in the related filter #1 and the improved related filter configuration #1.

The passing loss in the FM wave band is as follows. In the case of the filter circuitry 33 of the first embodiment, the passing loss is −0.7 dB at 76 MHZ (m12), −0.5 dB at 92 MHz (m13), and −0.6 dB at 108 MHZ (m14). There is hardly any passing loss of the signal including the signal transmission line in the entire FM wave band, and the variation (ripple) and the variation ratio of the passing loss are extremely small.

In contrast, the passing loss of the related filter #1 was −1.0 dB at 76 MHz (m12), −0.3 dB at 92 MHZ (m13), and −0.9 dB at 108 MHZ (m14). The passing loss of the improved related filter configuration #1 was −1.1 dB at 76 MHz (m12), −0.4 dB at 92 MHZ (m13), and −0.9 dB at 108 MHZ (m14).

As described above, in the case of the related filter #1 and the improved related filter configuration #1, the passband having a frequency width reduced by 3 dB from the passing loss of the center frequency of the BPF 333 is generally covered, but the passing loss in the FM wave band, the variation thereof, and the variation ratio thereof are higher than those of the filter circuitry 33 of the first embodiment.

As described above, as compared with the related filter #1 and the improved related filter configuration #1, the filter circuitry 33 of the first embodiment can ensure a high passing loss in a frequency band out of the FM wave band. In addition, it is possible to cause the passing loss in the FM wave band to extremely approach to zero, and to further limit the variation and the variation ratio of the passing loss. Therefore, for example, the signal can be transferred to the FM circuitry 34 in the subsequent stage without changing the gain frequency characteristics of the antenna.

One of the reasons why such passing loss characteristics are obtained is that the parallel resonance frequency of the first BEF 332 (150 MHz in this example) is set to a frequency equal to or higher than the upper limit frequency of the FM wave band (108 MHz in this example), and the parallel resonance frequency of the second BEF 334 (50 MHz in this example) is set to a frequency equal to or lower than the lower limit frequency of the FM wave band (76 MHz in this example). That is, it is because the signal transmission line has a rapidly increasing impedance and is substantially open near the upper limit frequency and near the lower limit frequency of the FM wave band.

Another reason why such passing loss characteristics are obtained is that the HPF 331 and the LPF 335 reduce the reactance of the BPF 333 and the variation thereof in the FM wave band at least, which as a result improves the VSWR. The effect of improving the VSWR is significant in the configuration example of FIG. 2. In the related filter #1 and the improved related filter configuration #1, the VSWR cannot be improved much.

That is, in the configuration example of FIG. 2, the VSWR was 1.3 at 76 MHz (m12), 1.1 at 92 MHZ (m13), and 1.2 at 108 MHz (m14), but in the case of the related filter #1, the VSWR was 1.8 at 76 MHz (m12), 1.2 at 92 MHz (m13), and 2.0 at 108 MHz (m14). In the case of the improved related filter configuration #1, the VSWR is 2.1 at 76 MHZ (m12), 1.1 at 92 MHz (m13), and 2.0 at 108 MHZ (m14), and the VSWR is higher than the configuration example in FIG. 2 at any frequency in the FM wave band.

In the configuration of the filter circuitry 33, the order of arrangement of the HPF 331, the first BEF 332, the BPF 333, the second BEF 334, and the LPF 335 (compatible frequency of each filter: frequency for passing or eliminating a signal) is also important. That is, the compatible frequencies between the input terminal T₁₁ and the output terminal T₁₂ in the first embodiment are desirably, when described in an ascending order, the first cutoff frequency of the HPF 331 (36 MHz)→the second elimination frequency of the second BEF 334 (50 MHz)→the center frequency of the BPF 333 (92 MHZ)→the first elimination frequency of the first BEF 332 (150 MHz)→the second cutoff frequency of the LPF 335 (190 MHz). The passing loss characteristics are not as illustrated in FIG. 4 if the order is changed.

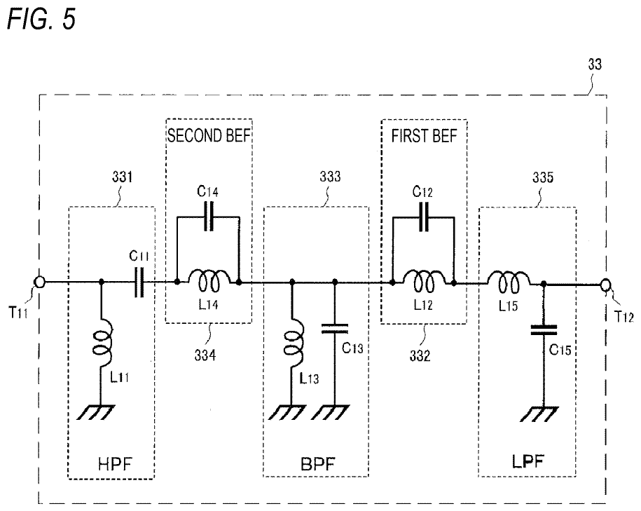

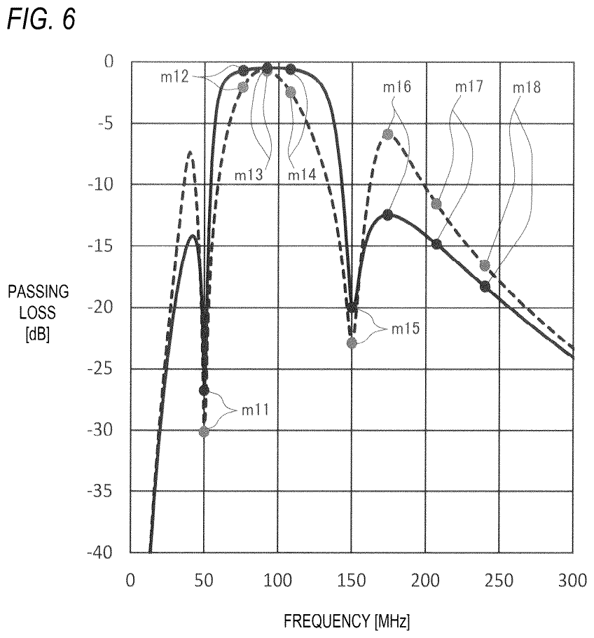

For example, assume that as illustrated in FIG. 5, the first BEF 332 and the second BEF 334 are interchanged (interchanged configuration #1). The interchanged configuration #1 has the same configuration as that of FIG. 2, except that the setting of the first elimination frequency and the second elimination frequency is reversed. The passing loss characteristics at this time are indicated by a broken line in FIG. 6. The solid line in FIG. 6 represents the passing loss characteristics according to the configuration example of FIG. 2. In the case of the interchanged configuration #1, the passing loss is −2.0 dB at 76 MHZ (m12), −0.7 dB at 92 MHz (m13), and −2.4 dB at 108 MHZ (m14), and the passing loss characteristics are higher than in the configuration example illustrated in FIG. 2 at any frequency in the FM wave band. In the case of the interchanged configuration #1, the bandwidth in which the passing loss is less than −1 dB is also narrower than that in the configuration example of FIG. 2.

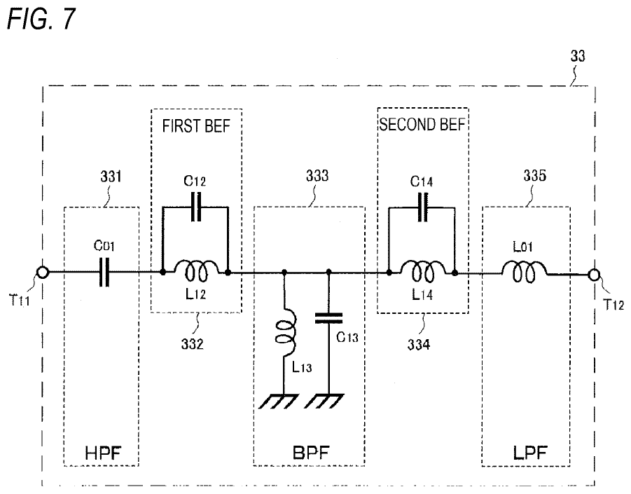

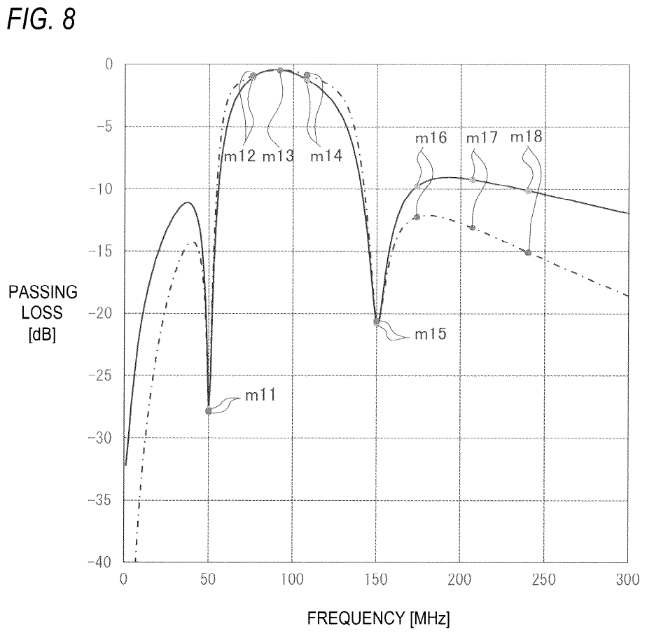

Each of the HPF 331 and the LPF 335 can be replaced with one reactance element. FIG. 7 is a configuration diagram of a filter circuit according to a modification of the configuration of FIG. 2 (modification #1). In the filter circuit according to the modification #1, the HPF 331 is replaced with a capacitor C₀₁ (for example, 47 pF) as an example of a capacitive element, and the LPF 335 is replaced with an inductor L₀₁ (for example, 82 nH) as an example of an inductive element. The passing loss characteristics according to the modification #1 illustrated in FIG. 7 are illustrated by a one-dot chain line in FIG. 8. A solid line in FIG. 8 illustrates the passing loss characteristics according to a configuration of only the first BEF 332, the BPF 333, and the second BEF 334, that is, a configuration of the filter circuitry 33 of the first embodiment illustrated in FIG. 2 excluding the HPF 331 and the LPF 335. For convenience, the configuration of only the first BEF 332, the BPF 333, and the second BEF 334 may be referred to as a “parallel basic configuration”.

In the case of the filter circuit according to the modification #1, the passing loss is-27.9 dB at 50 MHz (m11), −0.9 dB at 76 MHz (m12), −0.5 dB at 92 MHz (m13), −0.9 dB at 108 MHz (m14), −20.6 dB at 150 MHz (m15), −12.2 dB at 174 MHZ (m16) in the DAB band, −13.1 dB at 207 MHz (m17), and −15.1 dB at 240 MHz (m18). As described above, in the filter circuit according to the modification #1 as well, the passing loss of the signal is high in the DAB band, but the passing loss in the FM wave band is not much different from the parallel basic configuration.

The passing loss in the FM wave band in the filter circuit according to the modification #1 is −0.9 dB at 76 MHz (m12), −0.5 dB at 92 MHz (m13), and −0.9 dB at 108 MHz (m14), and the passing loss is less than −1.0 dB at any frequency in the FM wave band as in the parallel basic configuration. Therefore, each of the HPF 331 and the LPF 335 can be substituted with one reactance element, which has an effect that the configuration of the filter circuitry 33 can be further simplified.

The first embodiment has described an example in which T₁₁ is the input side and T₁₂ is the output side in the filter circuitry 33, but the same effect can be obtained if T₁₂ is the input side and T₁₁ is the output side.

As described above, the first embodiment can sufficiently ensure the attenuation amount of a signal at a frequency out of the FM wave band in the FM circuitry 34. For example, assume that a DAB broadcast signal is input to the filter circuitry 33 at a strong signal level. In such a case as well, since the attenuation amount of the signal in the DAB band is ensured sufficiently, it is possible to prevent a malfunction of the AGC circuit of the FM circuitry 34, a nonlinear operation of the amplifier, and a decrease in the C/N ratio.

### Second Embodiment

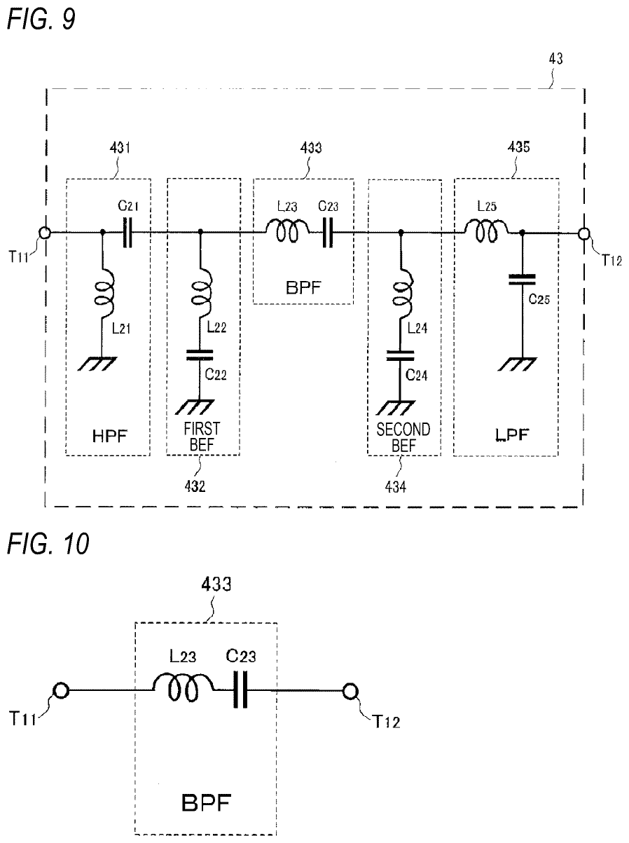

Next, a second embodiment of the present invention will be described. The second embodiment is different from the filter circuitry 33 of the circuit board 30 of the first embodiment in the specific configuration of the circuit board, particularly the filter circuitry. In a filter circuitry 43 of the circuit board 40 of the second embodiment, each filter is configured with a serial resonance circuit. By using serial resonance circuits as filters, the same effect as that of the first embodiment can be achieved. FIG. 9 illustrates a configuration example of the filter circuitry 43 of the second embodiment. In the filter circuitry 43, an HPF 431, a first BEF 432, a BPF 433, a second BEF 434, and an LPF 435 are inserted and connected in series in this order in a signal transmission line between the input terminal T₁₁ and the output terminal T₁₂.

The BPF 433 passes a signal in the FM wave band. In the second embodiment, the BPF 433 is configured with an LC serial resonance circuit in which an inductor L₂₃ and a capacitor C₂₃ are connected in series. In the BPF 433, the LC serial resonance circuit is resonant (shorted) for a signal at a frequency in the FM wave band. Therefore, a signal between the input and output terminals passes with a minimum passing loss. On the other hand, in the BPF 433, the LC serial resonance circuit is non-resonant in a frequency band out of the FM wave band. That is, the impedance between the input and output terminals corresponds to this frequency, the passing loss between the input and output terminals increases in a frequency band out of the resonant state, and the signal is attenuated.

The center frequency of the FM wave band is 92 MHz as in the first embodiment. In this case, the inductor L₂₃ is, for example, 130 nH, and the capacitor C₂₃ is, for example, 27 pF. The inductor L₂₃ and the capacitor C₂₃ may be connected in a reversed order.

The first BEF 432 and the second BEF 434 dividually eliminate passage of signals near the upper limit frequency and near the lower limit frequency of the FM wave band. Specifically, the first BEF 432 eliminates passage of a signal at a frequency in the first elimination frequency band. The first BEF 432 may be configured by, for example, connecting a capacitor C₂₂ whose other end is grounded and the other end of the inductor L₂₂ in series, and connecting one end of the inductor L₂₂ to the signal transmission line between the BPF 433 and the HPF 431. The connection order of the capacitor C₂₂ and the inductor L₂₂ may be reversed. The first elimination frequency band in the second embodiment is about 50 MHZ (about 150 MHz in the first embodiment). At this time, the inductor L₂₂ is, for example, 307 nH, and the capacitor C₂₂ is, for example, 42 pF.

The second BEF 434 eliminates passage of a signal at a frequency in the second elimination frequency band. The second BEF 434 may be configured by, for example, connecting a capacitor C₂₄ whose other end is grounded and the other end of the inductor L₂₄ in series, and connecting one end of the capacitor C₂₄ to the signal transmission line between the BPF 433 and the LPF 435. The connection order of the inductor L₂₄ and the capacitor C₂₄ may be reversed. The second elimination frequency band in the second embodiment is about 150 MHz (about 50 MHz in the first embodiment). At this time, the inductor L₂₄ is, for example, 120 nH, and the capacitor C₂₄ is, for example, 9.4 pF.

The HPF 431 eliminates passage of a signal at a frequency equal to or lower than the first cutoff frequency. The HPF 431 also has a function of matching the characteristic impedance of the antenna 10 with the impedance of the signal transmission line of the filter circuitry 43. The HPF 431 may include: a capacitor C₂₁ inserted and connected to a signal transmission line between the input and output terminals, that is, between the first BEF 432 and the BPF 433 and the input terminal T₁₁; and an inductor L₂₁ whose one end is connected between the input terminal T₁₁ and the capacitor C₂₁ and whose other end is grounded. The first cutoff frequency is 36 MHz (the same as in the first embodiment) and is a frequency lower than the first elimination frequency (50 MHz) of the first BEF 432. At this time, the capacitor C₂₁ is, for example, 33 pF, and the inductor L₂₁ is, for example, 330 nH.

The LPF 435 eliminates passage of a signal at a frequency equal to or higher than the second cutoff frequency. The LPF 435 also has a function of matching the input impedance of the FM circuitry 34 with the impedance of the signal transmission line of the filter circuitry 43. The LPF 435 may include: an inductor L₂₅ inserted and connected to a signal transmission line between the BPF 433 and the second BEF 434 and the output terminal T₁₂; and a capacitor C₂₅ whose one end is connected between the output terminal T₁₂ and the inductor L₂₅ and whose other end is grounded. The second cutoff frequency is 190 MHz (the same as in the first embodiment) and is a frequency higher than the second elimination frequency (150 MHz) of the second BEF 434. In this case, the inductor L₂₅ is, for example, 120 nH, and the capacitor C₂₅ is, for example, 10 pF.

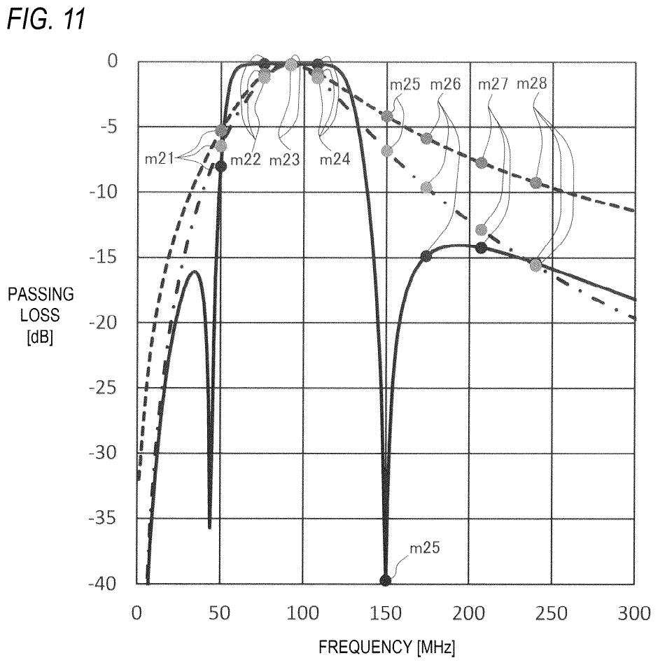

The passing loss characteristics of the filter circuitry 43 of the second embodiment configured as described above are illustrated by a solid line in FIG. 11. As a comparative example, the passing loss characteristics of a related filter #2 are indicated by a broken line. For example, as illustrated in FIG. 10, the related filter #2 has a simple configuration in which the BPF 433 of the second embodiment is connected between the input terminal Ti and the output terminal T₁₂, and the filter circuitry 43 is configured with the BPF 433 alone. In an improved related filter configuration #2 as another comparative example, the HPF 431 is directly connected to one end of the related filter #2 and the LPF 435 is directly connected to the other end of the related filter #2 (a configuration without being provided with the first BEF 432 or the second BEF 434 illustrated in FIG. 9). That is, in the improved related filter configuration #2, the filter circuitry 43 includes, for example, the HPF 431, the BPF 433, and the LPF 435 is connected between the input terminal T₁₁ and the output terminal T₁₂. The passing loss characteristics of the related improved configuration #2 are indicated by a one-dot chain line.

In FIG. 11, the vertical axis represents the passing loss (dB) of the signal transmission line, and the horizontal axis represents the frequency (MHz). m21 to m28 are points indicating the frequencies of interest for convenience of description.

m21 is 50 MHz which is the first elimination frequency of the first BEF 432, m22 is 76 MHz which is the lower limit frequency of the FM wave band, m23 is 92 MHz which is the center frequency of the FM wave band, m24 is 108 MHz which is the upper limit frequency of the FM wave band, and m25 is 150 MHz which is the second elimination frequency of the second BEF 434. Further, the frequencies corresponding to m26 to m28 are frequencies of interest in the DAB band (second frequency band). m26 indicates 174 MHZ, m27 indicates 207 MHz, and m28 indicates 240 MHz.

As illustrated in FIG. 11, the filter circuitry 43 of the second embodiment can obtain passing loss characteristics having substantially the same tendency as the filter circuitry 33 of the first embodiment. That is, in the case of the filter circuitry 43, the passing loss is −8.0 dB at 50 MHz (m21), −0.2 dB at 76 MHz (m22), −0.2 dB at 92 MHZ (m23), −0.2 dB at 108 MHZ (m24), and −39.7 dB at 150 MHz (m25).

In contrast, in the case of the related filter #2, the passing loss is −5.3 dB at 50 MHz (m21), −1.0 dB at 76 MHz (m22), −0.3 dB at 92 MHz (m23), −0.9 dB at 108 MHZ (m24), and −4.2 dB at 150 MHz (m25). In the case of the improved related filter configuration #2, the passing loss is −6.5 dB at 50 MHz (m21), −1.3 dB at 76 MHz (m22), −0.3 dB at 92 MHz (m23), −1.3 dB at 108 MHZ (m24), and −6.8 dB at 150 MHZ (m25). As described above, in the case of the related filter #2 and the improved related filter configuration #2, the passband having a frequency width reduced by 3 dB from the passing loss of the center frequency of the BPF 433 is generally covered, but the passing loss in the FM wave band, the variation thereof, and the variation ratio thereof are higher than those of the filter circuitry 43 of the second embodiment.

Focusing on the DAB band, in the case of the filter circuitry 43 of the second embodiment, the passing loss is −14.9 dB at 174 MHZ (m26), −14.2 dB at 207 MHz (m27), and −15.4 dB at 240 MHz (m28). On the other hand, in the case of the related filter #2, the passing loss is −5.9 dB at 174 MHZ (m26), −7.7 dB at 207 MHz (m27), and −9.3 dB at 240 MHz (m28), and in the case of the improved related filter configuration #2, the passing loss is −9.6 dB at 174 MHz (m26), −12.9 dB at 207 MHz (m27), and −15.6 dB at 240 MHz (m28). The passing loss of the filter circuitry 43 of the second embodiment is higher at a frequency equal to or lower than the second cutoff frequency of the LPF 435.

The variation and variation ratio of the passing loss in the FM wave band are as follows. In the case of the filter circuitry 43 of the second embodiment, the passing loss is −0.2 dB at 76 MHz (m22), −0.2 dB at 92 MHZ (m23), and −0.2 dB at 108 MHZ (m24). There is hardly any passing loss of the signal including the signal transmission line and hardly any variation thereof. In contrast, the passing loss of the related filter #2 is −1.0 dB at 76 MHz (m22), −0.3 dB at 92 MHZ (m23), and −0.9 dB at 108 MHZ (m24). The passing loss increases near the lower limit frequency and near the upper limit frequency of the FM wave band than in the filter circuitry 43 of the second embodiment. In particular, the variation in the passing loss is significant near the upper limit frequency of the FM wave band.

As described above, as compared with the related filter #2 and the improved related filter configuration #2, the filter circuitry 43 of the second embodiment can ensure a high passing loss in a frequency band out of the FM wave band. In addition, it is possible to cause the passing loss in the FM wave band to extremely approach to zero, and to further limit the variation and the variation ratio of the passing loss. Therefore, for example, the signal can be transferred to the FM circuitry 34 in the subsequent stage without changing the gain frequency characteristics of the antenna.

One of the reasons why such passing loss characteristics are obtained is that the first elimination frequency of the first BEF 432 (about 50 MHz) is set to a frequency equal to or lower than the lower limit frequency of the FM wave band (76 MHZ), and the second elimination frequency of the second BEF 434 (150 MHz) is set to a frequency equal to or higher than the upper limit frequency of the FM wave band (108 MHZ), and the signal transmission line has a small impedance and is substantially shorted at each compatible frequency.

Another reason why such passing loss characteristics are obtained is that by adding the HPF 431 and the LPF 435, the value of the reactance and the variation ratio thereof are reduced and the VSWR is improved at least in the FM wave band. The effect of reducing the reactance and the variation thereof by the HPF 431 and the LPF 435 is significant in the configuration example of FIG. 9. In the related filter #2 and the improved related filter configuration #2, the reactance value and the variation ratio thereof are not changed much, and the VSWR is not improved.

For example, in the configuration example of FIG. 9, the VSWR is 1.1 at 76 MHz (m22), 1.2 at 92 MHZ (m23), and 1.1 at 108 MHZ (m24), but in the case of the related filter #2, the VSWR is 1.5 at 76 MHZ (m22), 1.6 at 92 MHZ (m23), and 3.1 at 108 MHZ (m24). In the case of the improved related filter configuration #2, the VSWR is 1.7 at 76 MHz (m22), 2.1 at 92 MHz (m23), and 5.3 at 108 MHZ (m24), and VSWR is higher than the configuration example in FIG. 9 at any frequency in the FM wave band.

As in the case of the first embodiment, the configuration of the filter circuitry 43 has a certain rule on the order of the arrangement of the HPF 431, the first BEF 432, the BPF 433, the second BEF 434, and the LPF 435 (compatible frequency of each filter). That is, the compatible frequencies from the input terminal Ti to the output terminal T₁₂ in the second embodiment are desirably, when described in an ascending order, the first cutoff frequency of the HPF 431 (36 MHZ)→the first elimination frequency of the first BEF 432 (50 MHZ)→the center frequency of the BPF 433 (92 MHZ)→the second elimination frequency of the second BEF 434 (150 MHz)→the second cutoff frequency of the LPF 435 (190 MHz). The passing loss characteristics are not as illustrated in FIG. 11 if the order is changed.

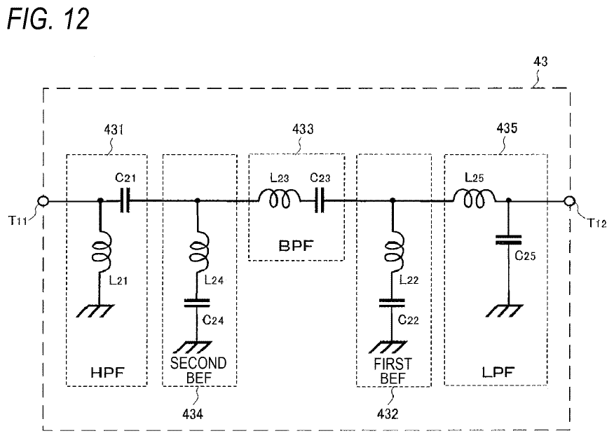

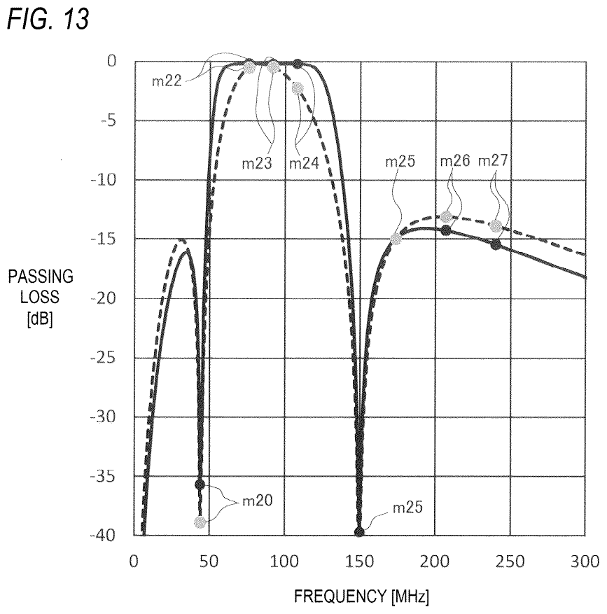

For example, assume that as illustrated in FIG. 12, the first BEF 432 and the second BEF 434 are interchanged (interchanged configuration #2). The interchanged configuration #2 has the same configuration as that of FIG. 9, except that the setting of the first/second elimination frequencies is reversed. The passing loss characteristics of the interchanged configuration #2 are indicated by a broken line in FIG. 13. The solid line in FIG. 13 represents the passing loss characteristics of the filter of the second embodiment illustrated in FIG. 9. In the case of the filter of the second embodiment, the passing loss is −0.2 dB at 76 MHz (m22), −0.2 dB at 92 MHZ (m23), and −0.2 dB at 108 MHZ (m24), but in the case of the interchanged configuration #2, the passing loss is −0.5 dB at 76 MHz (m22), −0.5 dB at 92 MHZ (m23), and −2.3 dB at 108 MHZ (m24). In particular, the increase in passing loss is significant near the upper limit frequency of the FM wave band, and the variation in passing loss is also higher than in the serial basic configuration.

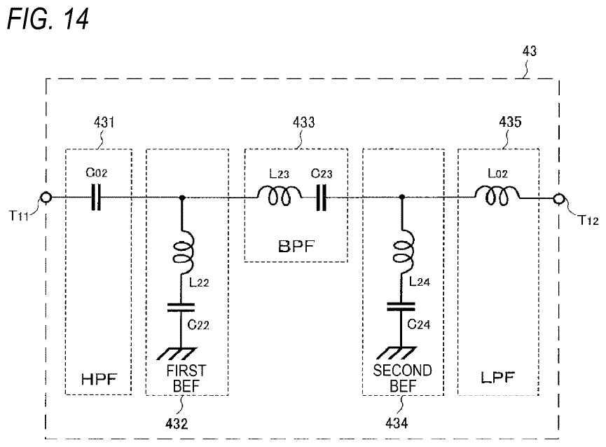

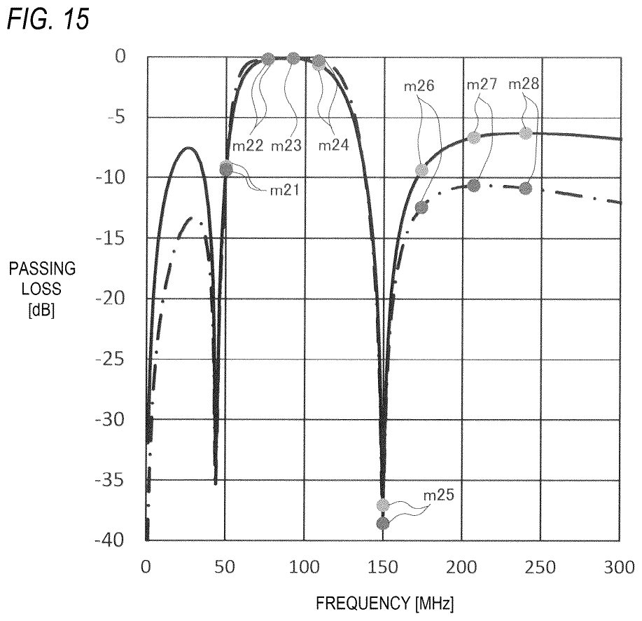

As in the first embodiment, each of the HPF 431 and the LPF 435 can be replaced with one reactance element. FIG. 14 is a configuration diagram of a filter circuit according to a modification of the configuration of FIG. 9 (modification #2). In the filter circuit according to the modification #2, the HPF 431 is replaced with a capacitor C₀₂ (for example, 43 pF) as an example of a capacitive element, and the LPF 435 is replaced with an inductor L₀₂ (for example, 75 nH) as an example of an inductive element. The passing loss characteristics of the modification #2 are indicated by a one-dot chain line in FIG. 15. A solid line in FIG. 15 illustrates the passing loss characteristics according to a configuration of only the first BEF 432, the BPF 433, and the second BEF 434, that is, a configuration of the filter circuitry of the second embodiment illustrated in FIG. 9 excluding the HPF 431 and the LPF 435. For convenience, the configuration of only the first BEF 432, the BPF 433, and the second BEF 434 may be referred to as a “serial basic configuration”.

In the case of the filter circuit according to the modification #2, the passing loss is-9.4 dB at 50 MHz (m21), −0.2 dB at 76 MHz (m22), −0.1 dB at 92 MHZ (m23), −0.3 dB at 108 MHz (m24), −38.5 dB at 150 MHz (m25), −12.4 dB at 174 MHZ (m26) in the DAB band, −10.6 dB at 207 MHz (m27), and −10.9 dB at 240 MHz (m28). As described above, in the modification #2 as well, the passing loss of the signal is high at all the frequencies in the DAB band, but the passing loss in the FM wave band is not much different from the serial basic configuration.

In addition, the VSWR in the FM wave band is 1.4 at 76 MHZ (m22), 1.2 at 92 MHz (m23), and 2.0 at 108 MHZ (m24) in the case of the serial basic configuration, and is 1.1 at 76 MHz (m22), 1.2 at 92 MHZ (m23), and 1.1 at 108 MHZ (m24) in the case of the modification #2, which are not different much. Therefore, each of the HPF 331 and the LPF 335 can be substituted with one reactance element, which has an effect that the configuration of the filter circuitry 43 can be further simplified.

The passing loss in the FM wave band in the filter circuit according to the modification #2 is −0.2 at 76 MHz (m12), −0.1 at 92 MHZ (m13), and −0.3 at 108 MHZ (m14), and the passing loss is less than 1.0 at any frequency in the FM wave band as in the serial basic configuration. Therefore, each of the HPF 431 and the LPF 435 can be substituted with one reactance element, which has an effect that the configuration of the filter circuitry 43 can be further simplified.

The second embodiment has described an example in which T₁₁ is the input side and T₁₂ is the output side in the filter circuitry 43, but the same effect can be obtained if T₁₂ is the input side and T₁₁ is the output side.

As described above, the filter circuitry 43 of the second embodiment has substantially the same effect as the filter circuitry 33 of the first embodiment. From this, it can be understood that one of the reasons why, for example, the attenuation amount of the DAB band can be increased sufficiently is due to the configuration in which the first BEF 332, 432 and the second BEF 334, 434 for eliminating passage of a signal at a frequency out of the FM wave band are connected to the input side and the output side of the BPF 333, 433.

Further, as described above, the passive circuit that sufficiently attenuates a signal at a frequency out of the FM wave band while limiting the passing loss in the FM wave band and the variation ratio thereof is the part of the parallel basic configuration in the first embodiment, and is the part of the serial basic configuration in the second embodiment. Therefore, the filter circuit may be configured with the parallel basic configuration or the serial basic configuration alone.

Further, at least one of the HPF 331, 431 and the LPF 335, 435 may be omitted, or at least one may be replaced with a reactance element.

### Third Embodiment

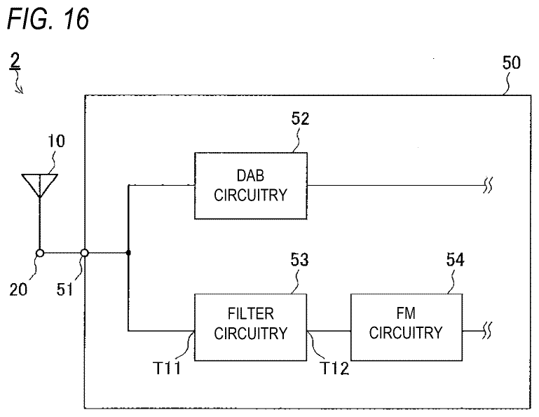

FIG. 16 is a block diagram illustrating a configuration example of an antenna device according to a third embodiment. The antenna device 2 is different from those of the first and second embodiments in the configuration of the circuit board. The antenna 10 receives signals in a plurality of frequency bands, for example, the DAB band and the FM wave band.

In the circuit board 50, a DAB circuitry 52 for processing a DAB signal and a filter circuitry 53 are connected to an antenna connection terminal 51 electrically connected to the power supply unit 20 of the antenna 10, and the subsequent stage of the filter circuitry 53 is provided with an FM circuitry 54. The filter circuitry 53 is the filter circuitry 33 of the first embodiment or the filter circuitry 43 of the second embodiment. The FM circuitry 54 may have the same configuration as the FM circuitry 34 of the first embodiment, for example.

In the antenna device 2 of the third embodiment, due to the filter circuitry 53, the passing loss of the signal in the frequency band out of the FM wave band is significantly higher than that of the filter disclosed in Patent Literature 1, for example, and the passing loss increases rapidly near the lower limit frequency and near the upper limit frequency of the FM wave band. Therefore, a flow into the DAB circuitry 52 of a spurious occurring from the FM circuitry 54 can be eliminated. In addition, even if a signal that hinders the operation of the FM circuitry 54 is input from the antenna 10 or the DAB circuitry 52 to the filter circuitry 53, a flow of the signal into the FM circuitry 54 can be eliminated.

### Fourth Embodiment

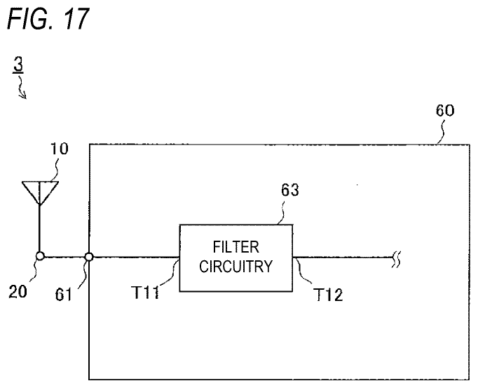

FIG. 17 is a diagram illustrating a configuration example of an antenna device according to a fourth embodiment. An antenna device 3 of the fourth embodiment is different from the circuit board 30 of the first embodiment and the circuit board 50 of the third embodiment in the configuration of the circuit board. The antenna 10 and the power supply unit 20 are the same as those in the first to third embodiments. In a circuit board 60 of the fourth embodiment, the input terminal T₁₁ of a filter circuitry 63 is connected to an antenna connection terminal 61. The filter circuitry 63 can be either the filter circuitry 33 of the first embodiment or the filter circuitry 43 of the second embodiment. An external electronic circuitry or the like is connected to the output terminal T₁₂ of the filter circuitry 63 via a feeder or the like.

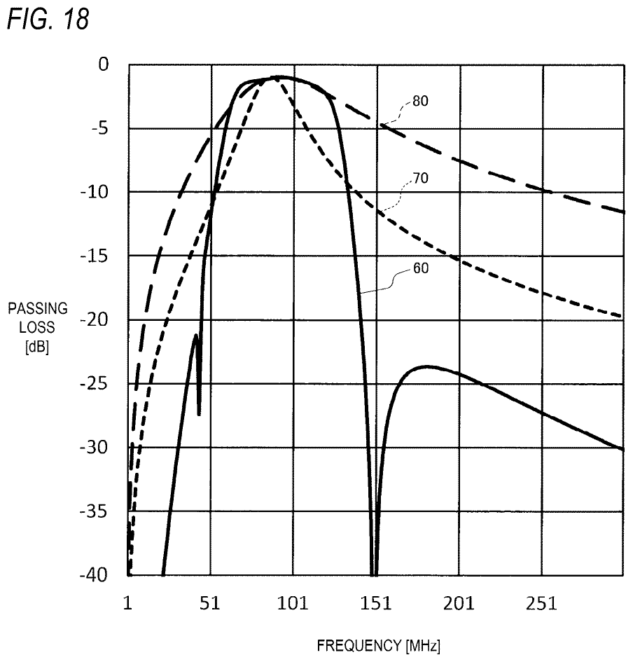

The passing loss characteristics of the antenna 10 and the circuit board 60 in the case of using the filter circuitry 43 of the second embodiment as the filter circuitry 63 connected to the antenna 10 are illustrated by a solid line in FIG. 18. In FIG. 18, the vertical axis represents the passing loss (dB) of the signal transmission line, and the horizontal axis represents the frequency (MHz). The passing loss characteristics of a circuit board 70 as a comparative example (not illustrated) provided with a related filter including only the antenna 10 and the BPF are indicated by a short broken line, and the passing loss characteristics of a circuit board 80 (not illustrated) provided with neither the BPF nor the filter circuitry 63 only the antenna 10 are indicated by a long broken line. It can be seen from FIG. 18 that the passing loss at a frequency out of the FM wave band increases in the order of circuit board 80<circuit board 70<circuit board 60. Further, in the FM wave band, the circuit board 60 has characteristics that are shift in parallel while maintaining the passing loss characteristics of only the circuit board 80, whereas the ripple of the circuit board 70 is high. As described above, by simply adding the filter circuitry 63 to the antenna 10, it is possible to ensure the out-of-band attenuation amount while limiting the ripple in the passband more than the related filter. For example, the antenna 10 may be a glass antenna (film-shaped antenna) attached to a window glass of a vehicle or an antenna attached to a roof, and the options for the antenna 10 incorporated in the antenna device can be expanded.

### Other Modifications

The above has described an example in which the first frequency band is the FM wave band and the second frequency band is the DAB wave band, but the present invention can also be implemented with other combinations of frequency bands. Examples thereof include combinations of the FM band and the DTV band, the FM band and the GNSS band, the FM band and the SXM band, the FM band and the TEL band, the FM band and the V2X band, the DTV band and the V2X band, the GNSS band and the V2X band, the FM band and another frequency band for in-vehicle devices, and the like.

The first to fourth embodiments have described examples of electronic circuits incorporated in an antenna case of an antenna device mounted on a vehicle, but can also be applied as an electronic circuit for a mobile object antenna device in which a plurality of circuitries are mounted in a narrow space, such as a drone or a robot.

The first to fourth embodiments have shown examples in which lumped constants are used for the elements, but the same effect can be obtained by using distributed constants.

The features of the electronic circuit described above can be summarized as the following aspects.

### Aspect 1

An electronic circuit for antenna device, the electronic circuit being configured to be connected to an antenna and including: a band pass filter (BPF) configured to pass a signal in a target frequency band (for example, the FM wave band); a first band elimination filter (first BEF) whose one end is connected to one end of the band pass filter; and a second band elimination filter (second BEF) whose one end is connected to the other end of the band pass filter, in which the first band elimination filter and the second band elimination filter dividually eliminate passage of signals at frequencies out of the target frequency band.

According to the electronic circuit of aspect 1, the passing loss at a frequency out of the target frequency band is significantly higher than that in the case of the band pass filter (BPF) alone, which limits spuriouses. In addition, since the first band elimination filter (first BEF) and the second band elimination filter (second BEF) eliminate the passage of a signal at a frequency out of the target frequency band, signals of such frequencies are limited from mixing into the target frequency band. Therefore, the occurrence of distortion of the pass characteristics and variation of the passing loss is limited as compared with the case without the first band elimination filter or the second band elimination filter.

### Aspect 2

The electronic circuit according to the configuration according to aspect 1, in which one of the first band elimination filter and the second band elimination filter eliminates passage of a signal at a frequency near a lower limit frequency of the target frequency band, and the other of the first band elimination filter and the second band elimination filter eliminates passage of a signal at a frequency near an upper limit frequency of the target frequency band.

According to the electronic circuit of aspect 2, the passing loss near the lower limit frequency and near the upper limit frequency of the target frequency band can be increased rapidly.

### Aspect 3

The electronic circuit according to the configuration of aspect 1, in which at least one of the other end of the first band elimination filter and the other end of the second band elimination filter includes one or more reactance elements configured to limit a reactance variation of a signal passing through the band pass filter.

According to the electronic circuit of aspect 3, the VSWR in the target frequency band can be reduced over the entire band.

### Aspect 4

The electronic circuit according to the configuration of any one of aspects 1 to 3, further including: an antenna connection terminal connected to the antenna, in which the antenna connection terminal is provided between the antenna and the first band elimination filter.

According to the electronic circuit of aspect 4, the same effect as that of the electronic circuit of aspects 1 to 3 can be achieved even if the antenna is capable of transmitting and receiving signals of a plurality of media and specification frequency bands.

### Aspect 5

An electronic circuit for antenna device, the electronic circuit being configured to be connected to an antenna configured to be used in a first frequency band and a second frequency band higher than the first frequency band, and including: a first circuitry configured to process a signal in the first frequency band; and a second circuitry connected to the first circuitry via a filter circuitry and configured to process a signal in the second frequency band, in which the filter circuitry includes a band pass filter (BPF) configured to pass the signal in the first frequency band, a first band pass filter (first BEF) whose one end is connected to one end of the band pass filter and whose other end is conducted to one of the first circuitry and the second circuitry, and a second band elimination filter (second BEF) whose one end is connected to the other end of the band elimination filter and whose other end is conducted to the other of the first circuitry and the second circuitry, and the first band elimination filter and the second band elimination filter dividually eliminate passage of signals at frequencies equal to or lower than a lower limit frequency of the second frequency band, and near an upper limit frequency and near a lower limit frequency of the first frequency band.

According to the electronic circuit of aspect 5, it is possible to rapidly increase the passing loss near the upper limit frequency and near the lower limit frequency of the first frequency band at or below the lower limit frequency of the second frequency band. Therefore, the effect of spuriouses due to malfunction or the like of one of the first circuitry and the second circuitry on the other circuit is limited, and the isolation between the first circuitry and the second circuitry can be enhanced significantly even in the case of being close due to the limitation of the arrangement space.

### Aspect 6

The electronic circuit according to aspect 5, in which the filter circuitry further includes a high-pass filter (HPF) or a capacitor configured to eliminate passage of a signal equal to or lower than a first cutoff frequency lower than a first elimination frequency band, which is the lower one between the first band elimination filter and the second band elimination filter, and a low-pass filter (LPF) or an inductor configured to eliminate passage of a signal equal to or higher than a second cutoff frequency higher than a second elimination frequency band, which is the higher one between the first band elimination filter and the second band elimination filter.

According to the electronic circuit of aspect 6, the high-pass filter or capacitor eliminates the passage of a direct current or low-frequency signal, and the low-pass filter or inductor eliminates the passage of high-modulation waves and other spuriouses. Therefore, the passing loss and the variation thereof in the target frequency band can be reduced, which can improve the VSWR of the entire target frequency band.

### Aspect 7

The electronic circuit according to aspect 5 or 6, in which the first band elimination filter eliminates passage of a signal in a second elimination frequency band equal to or lower than the lower limit frequency of the second frequency band and equal to or higher than the upper limit frequency of the first frequency band, and the second band elimination filter eliminates passage of a signal in a first elimination frequency band equal to or lower than the lower limit frequency of the first frequency band.

According to the electronic circuit of aspect 7, it is possible to increase the passing loss of frequencies equal to or higher than the upper limit frequency and equal to or lower than the lower limit frequency of the first frequency band, and it is possible to increase the isolation not only from the second frequency band but also from a frequency band lower than the first frequency band, such as the AM wave band.

### Aspect 8

The electronic circuit according to aspect 5 or 6, in which the first band elimination filter eliminates passage of a signal in a first elimination frequency band equal to or lower than the lower limit frequency of the first frequency band, and the second band elimination filter eliminates passage of a signal in a second elimination frequency band equal to or lower than the second frequency band and equal to or higher than the upper limit frequency of the first frequency band.

According to the electronic circuit of aspect 8, the same effect as Aspect 6 can be achieved.

### Aspect 9

The electronic circuit according to aspect 6, in which when viewed from the first circuitry or the second circuitry, compatible frequencies in the filter circuitry increase in order of the first cutoff frequency, a center frequency of the second elimination frequency band, a center frequency of the first frequency band, a center frequency of the first elimination frequency band, and the second cutoff frequency.

According to the electronic circuit of aspect 9, it is possible to limit the passing loss and the variation thereof in the entire target frequency band and to improve the VSWR in the entire target frequency band, regardless of the circuit configuration of the band pass filter, the first band elimination filter, and the second band elimination filter.

### Aspect 10

The electronic circuit according to aspect 6, in which when viewed from the first circuitry or the second circuitry, compatible frequencies in the filter circuitry increase in order of the first cutoff frequency, a center frequency of the first elimination frequency band, a center frequency of the first frequency band, a center frequency of the second elimination frequency band, and the second cutoff frequency.

According to the electronic circuit of aspect 10, the same effect as the electronic circuit of Aspect 8 can be achieved.

### Aspect 11

The electronic circuit according to aspect 5, 6, 9, or 10, in which the filter circuit unit further includes an antenna connection terminal configured to be connected to the antenna.

According to the electronic circuit of aspect 11, the same effect as that of the electronic circuit of aspect 5, 6, 9, or 10 can be achieved even if the antenna is capable of transmitting and receiving signals of a plurality of media and specification frequency bands.

### Aspect 12

An antenna device including: an antenna; and an electronic circuit configured to be connected to the antenna, in which the electronic circuit includes a band pass filter configured to pass a signal in a target frequency band, a first band elimination filter whose one end is connected to one end of the band pass filter, and a second band elimination filter whose one end is connected to the other end of the band pass filter, and the first band elimination filter and the second band elimination filter dividually eliminate passage of signals at frequencies out of the target frequency band.

According to the antenna device of aspect 12, the passing loss at a frequency out of the target frequency band is significantly higher than that in the case of the band pass filter (BPF) alone, which limits spuriouses. Further, since the first band elimination filter (first BEF) and the second band elimination filter (second BEF) eliminate the passage of a signal at a frequency out of the target frequency band, the signals entering the target frequency band are reduced. Therefore, the occurrence of distortion of the pass characteristics and variation of the passing loss is limited as compared with the case without the first band elimination filter or the second band elimination filter.

### Aspect 13

An antenna device including: an antenna; and an electronic circuit configured to be connected to the antenna, in which the antenna is compatible with a first frequency band and a second frequency band higher than the first frequency band, the electronic circuit includes a first circuitry configured to process a signal in the first frequency band, and a second circuitry connected to the first circuitry via a filter circuitry and configured to process a signal in the second frequency band, the filter circuitry includes a band pass filter configured to pass the signal in the first frequency band, a first band pass filter whose one end is connected to one end of the band pass filter and whose other end is conducted to one of the first circuitry and the second circuitry, and a second band elimination filter whose one end is connected to the other end of the band elimination filter and whose other end is conducted to the other of the first circuitry and the second circuitry, and the first band elimination filter and the second band elimination filter dividually eliminate passage of signals at frequencies equal to or lower than a lower limit frequency of the second frequency band, and near an upper limit frequency and near a lower limit frequency of the first frequency band.

According to the antenna device of aspect 13, it is possible to rapidly increase the passing loss near the upper limit frequency and near the lower limit frequency of the first frequency band at or below the lower limit frequency of the second frequency band. Therefore, the effect of spuriouses due to malfunction or the like of one of the first circuitry and the second circuitry on the other circuit is limited, and the isolation between the first circuitry and the second circuitry can be enhanced significantly even in the case of being close due to the limitation of the arrangement space.

### REFERENCE SIGNS LIST

1, 2, 3 antenna device
10 antenna
30, 50, 60 circuit board
31, 51, 61 antenna connection terminal
33, 43, 53, 63 filter circuitry
52 DAB circuitry
34, 54 FM circuitry
331, 431 HPF
332, 432 first BEF
333, 433 BPF
334, 434 second BEF
335, 435 LPF

1. An electronic circuit for antenna device, the electronic circuit being configured to be connected to an antenna and comprising:
a band pass filter configured to pass a signal in a target frequency band;
a first band elimination filter whose one end being connected to one end of the band pass filter; and
a second band elimination filter whose one end being connected to the other end of the band pass filter, wherein
the first band elimination filter and the second band elimination filter dividually eliminate passage of signals at frequencies out of the target frequency band.

2. The electronic circuit according to claim 1, wherein
one of the first band elimination filter and the second band elimination filter eliminates passage of a signal at a frequency near a lower limit frequency of the target frequency band, and
the other of the first band elimination filter and the second band elimination filter eliminates passage of a signal at a frequency near an upper limit frequency of the target frequency band.

3. The electronic circuit according to claim 1, wherein
at least one of the other end of the first band elimination filter and the other end of the second band elimination filter includes one or more reactance elements configured to limit a reactance variation of a signal passing through the band pass filter.

4. The electronic circuit according to claim 1, further comprising:
an antenna connection terminal connected to the antenna, wherein
the antenna connection terminal is provided between the antenna and the first band elimination filter.

5. An electronic circuit for antenna device, the electronic circuit being configured to be connected to an antenna configured to be used in a first frequency band and a second frequency band higher than the first frequency band, and comprising:
a first circuitry configured to process a signal in the first frequency band; and
a second circuitry connected to the first circuitry via a filter circuitry and configured to process a signal in the second frequency band, wherein
the filter circuitry includes
a band pass filter configured to pass the signal in the first frequency band,
a first band pass filter whose one end is connected to one end of the band pass filter and whose other end is conducted to one of the first circuitry and the second circuitry, and
a second band elimination filter whose one end is connected to the other end of the band elimination filter and whose other end is conducted to the other of the first circuitry and the second circuitry, and
the first band elimination filter and the second band elimination filter dividually eliminate passage of signals at frequencies equal to or lower than a lower limit frequency of the second frequency band, and near an upper limit frequency and near a lower limit frequency of the first frequency band.

6. The electronic circuit according to claim 5, wherein
the filter circuitry further includes
a high-pass filter or a capacitor configured to eliminate passage of a signal equal to or lower than a first cutoff frequency lower than a first elimination frequency band, which is the lower one between the first band elimination filter and the second band elimination filter, and
a low-pass filter or an inductor configured to eliminate passage of a signal equal to or higher than a second cutoff frequency higher than a second elimination frequency band, which is the higher one between the first band elimination filter and the second band elimination filter.

7. The electronic circuit according to claim 5 or 6, wherein
the first band elimination filter eliminates passage of a signal in a second elimination frequency band equal to or lower than the lower limit frequency of the second frequency band and equal to or higher than the upper limit frequency of the first frequency band, and
the second band elimination filter eliminates passage of a signal in a first elimination frequency band equal to or lower than the lower limit frequency of the first frequency band.

8. The electronic circuit according to claim 5, wherein
the first band elimination filter eliminates passage of a signal in a first elimination frequency band equal to or lower than the lower limit frequency of the first frequency band, and
the second band elimination filter eliminates passage of a signal in a second elimination frequency band equal to or lower than the lower limit frequency of the second frequency band and equal to or higher than the upper limit frequency of the first frequency band.

9. The electronic circuit according to claim 6, wherein
when viewed from the first circuitry or the second circuitry, compatible frequencies in the filter circuitry increase in order of the first cutoff frequency, a center frequency of the second elimination frequency band, a center frequency of the first frequency band, a center frequency of the first elimination frequency band, and the second cutoff frequency.

10. The electronic circuit according to claim 6, wherein
when viewed from the first circuitry or the second circuitry, compatible frequencies in the filter circuitry increase in order of the first cutoff frequency, a center frequency of the first elimination frequency band, a center frequency of the first frequency band, a center frequency of the second elimination frequency band, and the second cutoff frequency.

11. The electronic circuit according to claim 5, wherein
the filter circuitry further includes an antenna connection terminal configured to be connected to the antenna.
